(19) United States
(12) Patent Application Publication
(10) Pub. No.: US 2020/0139809 A1
(43) Pub. Date: May 7, 2020

(54) TANK OF A MOTOR VEHICLE HAVING A VOLUME ELEMENT

(71) Applicant: KAUTEX TEXTRON GMBH & CO. KG, Bonn (DE)

(72) Inventors: Daniel HARMS, Siegburg (DE); Gernot WEISS, Neunkirchen-Seelscheid (DE); Roman BOUFFIER, Koenigswinter (DE); Emmanuel ARRAS, Muenchen (DE); Markus HUBER, Muenchen (DE); Axel FROHWEIN, Neufahrn (DE); Attila FARKAS, Muenchen (DE)

(21) Appl. No.: 16/625,242

(22) PCT Filed: Jun. 12, 2018
(86) PCT No.: PCT/EP2018/065484

§ 371 Date: Dec. 20, 2019

(30) Foreign Application Priority Data
Jun. 22, 2017 (DE) 10 2017 210 574.7

(51) Int. Cl. B60K 15/077; B60K 15/03

(52) U.S. Cl. CPC B60K 15/077; B60K 2015/03296; B60K 2015/0777; B60K 15/03006

(57) ABSTRACT

The invention relates to a tank, in particular a fuel tank, for receiving a liquid in a motor vehicle, comprising an outer wall that forms an internal space for receiving the liquid, at least one volume element situated in the internal space for receiving gas, in particular air, a gas-guiding line between the volume element and the surroundings of the tank for changing the volume of the volume element, and at least one stabilizing assembly for minimizing stresses at kinks of the volume element when evacuating the volume element.

The invention relates to a tank in a motor vehicle for receiving a liquid, in particular a fuel. The tank has a gas-filled volume element with a changeable volume.

Hydrocarbon emissions from fuel tanks must be avoided to the greatest extent possible due to their harmful effect on the environment. Hydrocarbon vapors result on account of the high partial pressure of the hydrocarbons in fuel, in particular at elevated temperatures. Three important processes contribute to the potential escape of hydrocarbon vapors from the fuel tank. One process is permeation of the hydrocarbon molecules through the outer wall of the tank. This process is largely understood, and current solutions have resulted in adequate reduction of the emissions. A second process is the refueling process. Filling the tank with liquid fuel requires displacement of the gas, which is saturated with hydrocarbons, present in the tank. There are two main approaches for collecting these gases: onboard refueling vapor recovery (ORVR) using large active carbon filters (ACF), or drawing the gas through the refueling nozzle at the filling station by suction. Thirdly, gases, so-called diurnal or parking emissions, are emitted due to a change in the ambient temperature when the vehicle is parked or the internal combustion engine is not running. These emissions as well may be dealt with using an active carbon filter when an adequate purging process of the active carbon filter is regularly carried out. For this purpose, the internal combustion engine must typically be operating. This may be relatively complicated in particular in hybrid vehicles having an electric motor and an internal combustion engine, since the internal combustion engine is not always in operation.

One option for reducing the HC emissions without closing off the tank is to implement a pressureless tank having an integrated volume element that compensates for the resulting gas volume by a change in volume. For this purpose, the volume element must be sealed off as tightly as possible with regard to hydrocarbon emissions so that its interior always contains air, which may be pressed out of the tank system and directly into the atmosphere, or drawn into the tank system. In addition, the volume element must be so easily deformable that a very small pressure difference of a few millibars is sufficient to ensure complete filling and emptying. Furthermore, the volume of the volume element must be designed in such a way that the gas volume that results due to evaporation when the temperature increases, up to the saturation point, may be compensated for in a pressure-neutral manner.

WO 2016/012284 discloses various embodiments of the volume element, and also describes bladders made of elastic materials as well as folded film structures and folded structures made of rigid elements.

The object of the invention is to provide a tank, in particular a fuel tank, of a motor vehicle that has a simple design and allows the most low-maintenance and reliable operation of the motor vehicle possible.

This object is achieved by the features of the independent claims. The subject matter of the dependent claims relates to advantageous embodiments of the invention.

The object is achieved by a tank, in particular designed as a fuel tank. The tank is designed for placement in a motor vehicle and for receiving a liquid. The motor vehicle is in particular a road vehicle, for example a passenger vehicle, truck, or motorcycle. The motor vehicle is particularly preferably a hybrid vehicle having an electric motor and an internal combustion engine. The liquid to be received by the tank is preferably fuel, for example gasoline or diesel fuel.

The tank includes an outer wall. This outer wall forms an internal space for receiving the liquid. The tank also includes at least one volume element that is situated in the internal space. The volume element is designed for receiving gas. The gas is in particular air from the surroundings of the tank.

The container volume formed by the outer wall, except for the volume that is occupied by the volume element, may thus be utilized for receiving the liquid.

Furthermore, the tank includes a line between the volume element and the surroundings of the tank. The line connects the volume element to the surroundings in a gas-conducting manner through the outer wall. The gas can flow out of the volume element to the outside through the line, and can flow from the outside into the volume element. This results in a change in the mass of gas in the volume element, so that the volume of the volume element also changes when the pressure in the internal space and/or the filling quantity in the internal space changes(s).

The gas is in particular air that is withdrawn from the atmosphere or that flows from the line back into the atmosphere. In particular, the air flows out of the volume container through a filter, preferably a dust filter, into the atmosphere.

In all variants disclosed herein, the volume element may preferably be made of a flexible and/or elastic material. The flexible material is a film, for example. The elastic material can stretch in places at kinks so that damage may be avoided. The volume element may also be referred to as a bladder.

The volume element may in particular be formed by a flat, folded, crumpled, and/or rolled structure. This structure may be made of a flexible and/or elastic material.

In particular, the volume of the volume element is at a minimum when the tank is completely filled with liquid, and is continuously filled with gas when liquid is withdrawn from the tank. Naturally it is possible for only a smaller quantity of fuel vapors to form above the liquid level in the tank, compared to an otherwise identical tank without such a volume element. In conjunction with a refilling of the tank, the volume element is then emptied into the surroundings. An alternative operating mode of the volume element is explained below: When the saturation vapor pressure of a fuel in the tank changes (when the vehicle is parked, for example), this change can be compensated for. For example, when the fuel temperature greatly fluctuates over the day (for example, 20° C. in the morning, 40° C. in the afternoon, 20° C. at night), the change in the saturation vapor pressure is compensated for by the volume element. The volume of the volume element is at a minimum at the maximum fuel temperature, while its volume is at a maximum at the minimum fuel temperature. WO 2016/012284 describes the functioning of the volume element in detail.

For the change in volume that is necessary for breathing, i.e., gas exchange between the volume element and the surroundings, folds may be formed in the volume element, which result in high stress states in the kink area of the material. In particular, folds arise during evacuation, i.e., the reduction in volume of the volume element.

The tank according to the invention preferably includes at least one stabilizing assembly for minimizing stresses at these kinks of the volume element which may occur during evacuation of the volume element. In particular, via the at least one stabilizing assembly the stresses are reduced in that the development of such kinks is reduced, and/or the radii at the kinks are kept as large as possible, and/or the volume element has an elastic design. It is thus possible to avoid damage to the volume element, in particular for cyclical mechanical load (for example, alternating pressure stress on the tank system) as well as leaking of the volume element.

A plurality of the volume elements described here may also be situated in the internal space of the tank. The volume elements and their stabilizing assemblies may have the same or different designs. In addition, a single volume element may have a plurality of the stabilizing assemblies described here. Thus, the stabilizing assemblies described here are combinable with one another in conjunction with the same volume element.

It is preferably provided that the stabilizing assembly has a coating and/or an internal body in the interior of the volume element. When the volume element is evacuated to its minimum volume, the volume element rests at least partially against the internal body. This ensures a residual volume of the volume element, with the “residual volume” being filled by the internal body and optionally by gas in remaining cavities. Since as a result of the internal body the volume element does not completely collapse, kinks are avoided, and any kinks that develop have the largest possible radius.

It is preferably provided that a ratio of the volume of the internal body to the maximum volume of the volume element is at most 1/20, preferably at most 1/10, particularly preferably at most 1/5. For the case of highly compressible internal bodies (flexible foams, for example), the compressed volume is applied for the calculation, i.e., the case of the emptied volume element.

The internal body preferably has an elastically deformable design. Depending on the design of the volume element, it is possible for the volume element to assume different geometries or shapes during each evacuation operation. Thus, the volume element may always contract, fold up, roll up, or crumple up differently. The internal body is easily deformable during the evacuation of the volume element, and forms a counterpressure for tightening the volume element. The elastically deformable internal body may always represent an optimal contact surface for the volume elements in order to largely avoid kinks.

The elastically deformable internal body is preferably formed by a gas-filled bladder. This bladder is situated in the interior of the volume element and is closed, so that the same mass of gas is always present in the bladder. The closed bladder is filled in particular with air.

In addition, it is provided that the internal body is made of an elastically deformable material. This elastically deformable material is for example a foamed material, in particular a foam or an elastomer.

Furthermore, it is preferably provided that the internal body is not only elastically deformable but also elastically compressible. For this purpose, it is preferably provided that the internal body is made of an open-pore (also referred to as open-cell) foam. In particular when the internal body is elastically compressible, a ratio of the volume of the internal body (in its uncompressed state) to the maximum volume of the volume element may be relatively large, in particular at least 1/4, preferably at least 1/3.

Moreover, it is preferably provided that the internal body is designed as a resilient structure. The resilient structure is elastically deformable. However, the resilient structure is elastically deformable primarily due to its geometric design and not the type of material of which it is made. During the evacuation of the volume element, the resilient structure is elastically deformed, and a counterpressure thus builds up on the volume element for tightening the volume element.

The resilient structure is formed in particular by a deformable hollow body. The hollow body is spherical, ovoidal, or cylindrical, for example. The cylindrical shape is preferably formed by a rolled film. The hollow body preferably has a relatively small wall thickness, so that it is deformable due to its geometric design. The wall thickness of the hollow body is preferably at most 5 mm, particularly preferably at most 3 mm.

The resilient structure may be made of a rigid material or an elastic material. It is also possible for one portion of the structure to be made of a rigid material, and another portion of the structure to be made of an elastic material.

It is preferably provided that the internal body is designed as a frame. The frame has in particular a round or oval shape. The frame is preferably rigid, and therefore is not, or essentially not, deformable. In particular, the frame in the inflated state of the volume element does not determine the shape of the volume element, and merely ensures tightening of the volume element when it is evacuated.

In addition, it is provided that the interior frame is polygonal, and thus has multiple mutually angled sides. In the inflated state the volume element rests against the frame and presses the sides inwardly during inflation. This takes place due to the fact that the volume of the volume element increases in both directions perpendicular to the frame during inflation, so that the circumference of the volume element resting against the frame can be deformed.

The frame may be loosely arranged in the interior of the volume element. Alternatively, it is also possible to fix the frame to the volume element in places, so that the position of the frame within the volume element is defined.

The internal body, in particular designed as a frame or elastic element, is preferably flat. This results in a flattened shape of the volume element in the evacuated state, with a residual volume in the evacuated state that is determined by the internal body.

It is also possible for a plurality of the described internal bodies, having the same or different designs, to be situated within the same volume element.

Furthermore, it is possible to combine the described embodiments of the internal body to form a single internal body. At least the following combinations are preferably provided: (i) In particular, an internal body may include the closed, gas-filled bladder, the elastically deformable material being situated on the surface of the bladder. (ii) In particular, an internal body may be designed as a resilient structure and may additionally have areas with the elastically deformable material. (iii) In particular, the internal body may have a rigid frame and may additionally have areas with the elastically deformable material and/or areas with a resilient structure.

Further advantageous embodiments of the stabilizing assembly are described below which may be combined with one another and also with at least one internal body:

It is preferably provided that the stabilizing assembly includes a stabilizing frame. The stabilizing frame is fixedly connected to the volume element. The stabilizing frame preferably extends around the full circumference of the volume element.

The stabilizing frame may be fastened to the inner side and/or outer side of the volume element and/or the interior of the wall that forms the volume element. The volume element is particularly preferably formed by two shell-shaped flexible parts, the stabilizing frame being situated on and/or in the seam region between the two parts. If the stabilizing frame is situated in the interior of the volume element, it may also be considered as an internal body.

It is preferably provided that the stabilizing frame is polygonal and thus has multiple mutually angled sides. The stabilizing frame preferably has at least three or more sides. The sides are preferably inwardly curved. The volume of the volume element increases in both directions perpendicular to the frame during inflation. In the process the stabilizing frame remains essentially dimensionally stable, wherein the inwardly curved sides may be slightly inwardly deformed.

It is preferably provided that the stabilizing assembly is formed by the volume element and an outer bladder that encloses the volume element. When the volume element has sufficient flexibility and/or elasticity, the formation of folds and corresponding kinks during contraction is largely avoided.

In this configuration, the volume element is preferably made of an elastomer or a silicone-containing material. These materials have a high maximum elongation at break, which makes bladders made of this material resistant to buckling loads. A disadvantage of the elastomers presently available on the market is either insufficient resistance to fuel, or increased hydrocarbon emissions in comparison to thermoplastic barrier materials. Therefore, it is proposed here to use an outer bladder that encloses the volume element and that is resistant to fuel and designed as a barrier against hydrocarbons. In particular an appropriate material that allows the lowest possible hydrocarbon emissions is used for this outer bladder.

The outer bladder may be flatly and integrally joined to the volume element.

Alternatively, it is also possible for the volume element to be situated solely within the outer bladder and not flatly joined to the outer bladder. For example, the outer bladder is fastened to the volume element only in the area of the opening in the volume element, or the outer bladder is fastened to the outwardly leading line.

Furthermore, it is preferably provided that the stabilizing assembly has a coating of the volume element, at least in places. The coating may be applied to the inner side and/or outer side of the volume element. A different material or the same material as on the outer side may be used on the inner side. In particular, it is taken into account that the material of the coating on the inner side is resistant to the gas that is used, and the material on the outer side is resistant to the liquid.

The coating is preferably made of an elastic material. In particular, the coating includes fluororubber (FKM), acrylonitrile butadiene rubber (NBR), or fluorosilicone rubber (FVMQ).

When the coating is used, the volume element is preferably made of a flat, folded, crumpled, or rolled structure made of a material with little or no elasticity, for example a film. The coating on the one hand reinforces the possible kinks and on the other hand forms an elastic design in order to avoid leaks at the volume element.

According to another preferred design, it is provided that the stabilizing assembly includes at least one elastic tension element that is situated in the internal space, outside the volume element. The tension element thus extends through the internal space, and is fastened to the volume element and also to the outer wall or some other solid element within the tank. The tension element is designed to exert a tensile force on the volume element, in particular when the volume element is not completely inflated. In particular, a plurality of these tension elements may be situated at various locations on the volume element.

The at least one tension element is in particular situated on the volume element in such a way that the volume element is drawn flat with decreasing volume. Kinks in the volume element during evacuation may thus be prevented.

The at least one tension element is preferably designed as a spring, for example a metallic coil spring or an elastomer element.

It is preferably provided that the stabilizing assembly is formed by a two-shell design of the volume element. The volume element thus includes a rigid first shell and a flexible second shell. The two shells together form the gas-receiving volume of the volume element. The rigid shell remains unchanged during the evacuation of the volume element, wherein the flexible shell may rest in the rigid shell, thus reducing the volume. During the evacuation, the rigid shell holds the flexible shell in a defined shape, thus avoiding unhindered formation of kinks.

According to one design, the rigid shell is situated at the top and the flexible shell is situated at the bottom. The flexible shell of the liquid in the tank thus faces the liquid in the tank, and the opening to the line is preferably on the rigid first shell.

Alternatively, the rigid shell is situated at the bottom. In particular, the lower shell thus comes into contact with the liquid. There are more options for avoiding the permeation with hydrocarbons with the rigid shell than with the flexible shell. The rigid shell may thus be made, for example, of an appropriate material and with an appropriate thickness.

It is preferably provided that the flexible shell is designed to be smaller (having a smaller volume) than the rigid shell, so that the flexible shell in the evacuated state of the volume element tightens and forms few or no folds. For this purpose, the flexible shell is preferably made of a stretchable material, in particular an elastomer, optionally with a coating, or is made of a nonelastomeric film.

According to one variant of the two-shell formation of the volume element, it is provided that the rigid shell is made of a rigid plastic or metal, and the flexible shell is fastened, in particular integrally bonded, to the rigid shell. The rigid shell may also be formed by a pliable film that is joined, for example welded, to a rigid structure such as a grid.

According to another variant of the two-shell formation of the volume element, it is provided that the entire volume element is formed by a stretchable bladder, in particular made of an elastomer. The rigid shell results from a rigid shell frame that is fixedly connected to a portion of the bladder. The shell frame has a shell-shaped design. It is provided that such a shell frame is situated on the inner side and/or the outer side of the bladder. The portion of the bladder that does not rest against the shell frame functions here as a flexible shell.

In the two-shell design, the section between the first and the second shell forms a circumferential geometry. The “circumferential geometry” is determined by the seam between the two shells or by the shape of the shell frame. The circumferential geometry may be round, oval, or polygonal. For a polygonal shape, it is provided in particular that the sides of the polygon are inwardly curved.

It is also preferably provided that the stabilizing assembly includes a shutoff valve in the line. The shutoff valve is used to block the line and thus prevent exchange of gas between the surroundings and the volume element. The shutoff valve may be situated in the internal space, in the outer wall, or outside the outer wall. The shutoff valve is used for maintaining a residual volume that is greater than 0 (the volume element).

The stabilizing assembly particularly preferably includes a control device. This control device is designed for closing the shutoff valve when the residual volume is reached.

In particular, the control device includes a detection unit that detects, for example via sensors or data from a higher-order unit, when the residual volume is reached. Based on this detected state, the control device may close the shutoff valve, for example electromagnetically. The control device is also preferably designed to reopen the shutoff valve and once again allow a gas exchange between the surroundings and the element.

The control device may also mechanically detect when the residual volume is reached. It is provided in particular that the movement of the volume element mechanically actuates the valve.

The described stabilizing assemblies may be combined with one another within a tank at different volume elements and/or at the same volume element. Thus, for example, at least one of the internal bodies and/or the stabilizing frame and/or the volume element together with an outer bladder and/or the coating of the volume element and/or at least one of the tension elements and/or the two-shell design and/or the shutoff valve may be used on a volume element.

The invention also includes one of the described tanks, which does not necessarily have to include the stabilizing assembly. However, this tank may also include one or more of the described stabilizing assemblies. For the tank, it is taken into account that replacing the volume element may be necessary, with or without a stabilizing assembly, since leaks may result in the volume element, for example due to stresses at kinks.

To allow reliable operation of the motor vehicle without replacing the entire tank, it is provided that the volume element is exchangeably situated in the internal space of the tank. For this purpose, the outer wall includes a service opening that is designed for removing and reinserting the volume element from/into the internal space. The service opening is thus large enough for the volume element, at least in its evacuated state, to be replaced. The service opening may be the hand hole, which is present anyway in most tanks, or an additional opening in the outer wall.

The tank preferably includes a connecting element, in particular that is actuatable without tools, on the line in the internal space. The volume element may be attached to and removed from the line, in particular without using a tool, via this connecting element. For example, the connecting element includes a union nut or a bayonet lock.

Additionally or as an alternative to using the connecting element, it is preferably provided that the service opening is closed by a cover that forms part of the outer wall. The line leads through this cover. The volume element is particularly preferably fastened only to this cover, for example via the line. By removing the cover, the volume element at the same time is withdrawn from the internal space. The new volume element may be attached to the cover and inserted together with the cover.

Further particulars, advantages, and features of the present invention result from the following description of exemplary embodiments with reference to the drawings, which show the following:

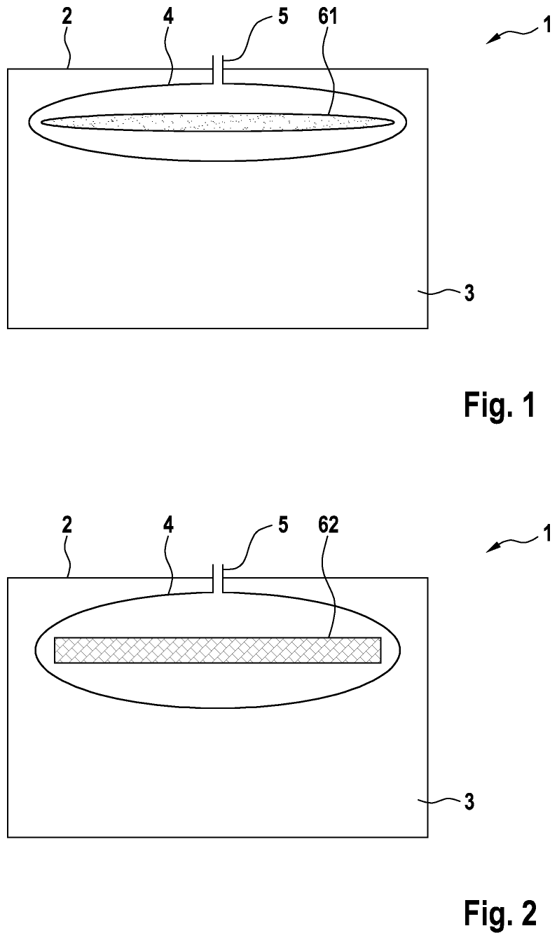

FIG. 1 shows a schematic view of a tank according to the invention having a volume element, and an internal body designed as a gas-filled bladder,

FIG. 2 shows a schematic view of a tank according to the invention having a volume element, and an internal body made of an elastically deformable material,

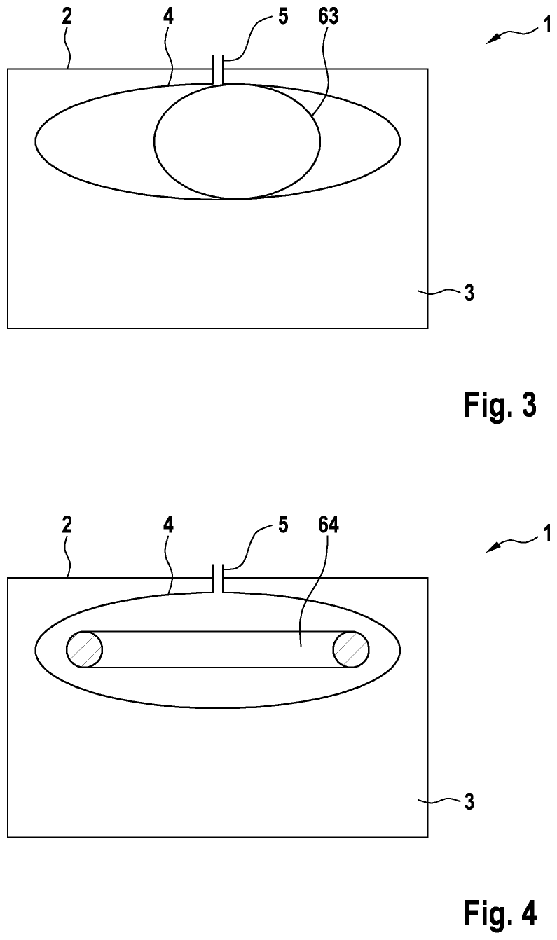

FIG. 3 shows a schematic view of a tank according to the invention having a volume element, and an internal body designed as a resilient structure,

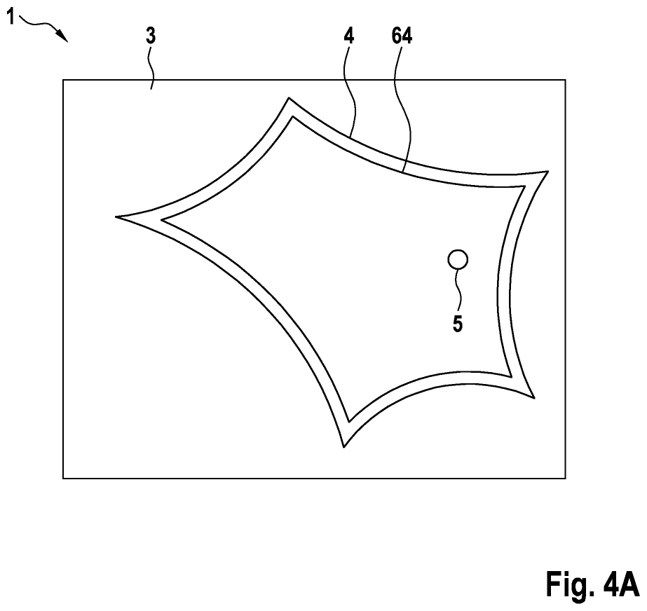

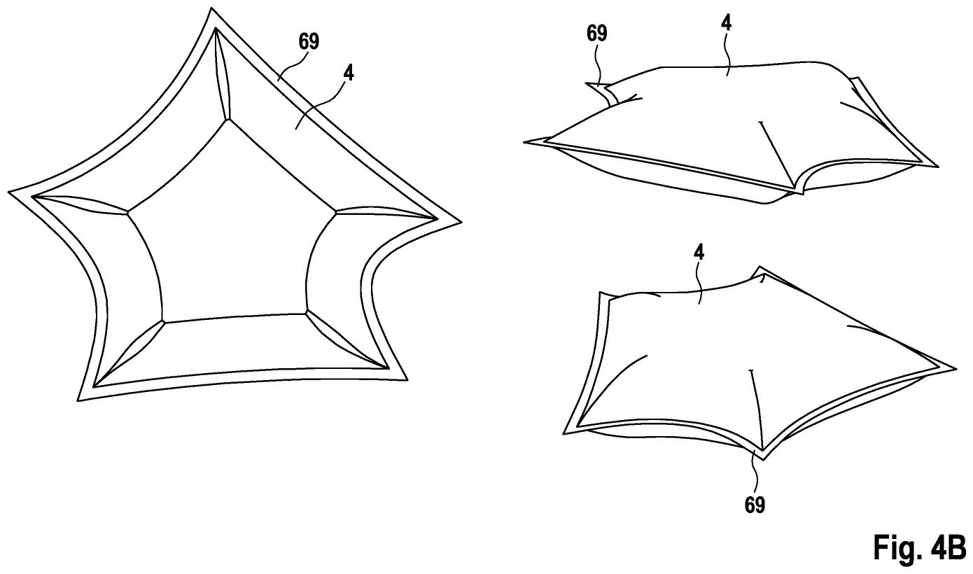

FIG. 4 shows a schematic view of a tank according to the invention having a volume element, and an internal body designed as a round or oval frame,

FIG. 4A shows a schematic view of a tank according to the invention having a volume element and an internal body, designed as a polygonal frame,

FIG. 4B shows a schematic view of the volume element together with a stabilizing frame,

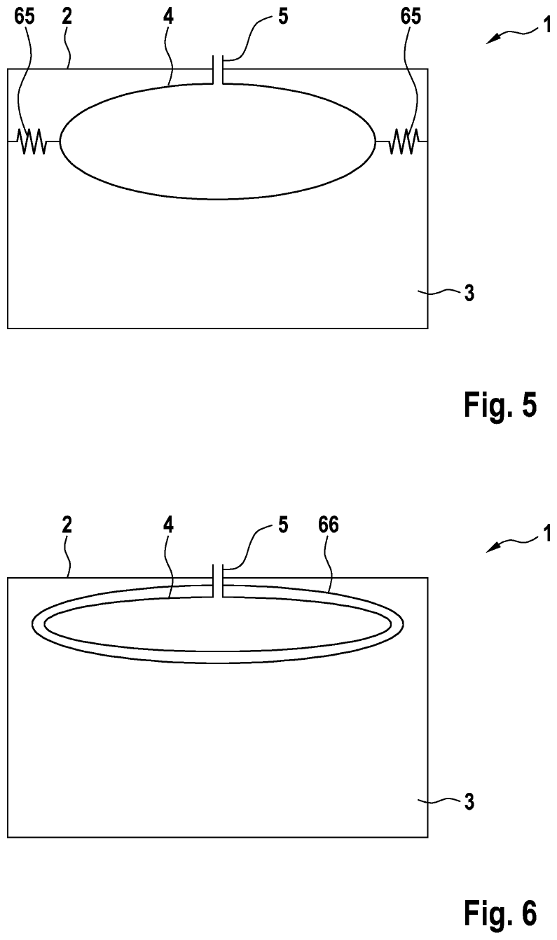

FIG. 5 shows a schematic view of a tank according to the invention having a volume element and tension elements,

FIG. 6 shows a schematic view of a tank according to the invention having a volume element and an outer bladder,

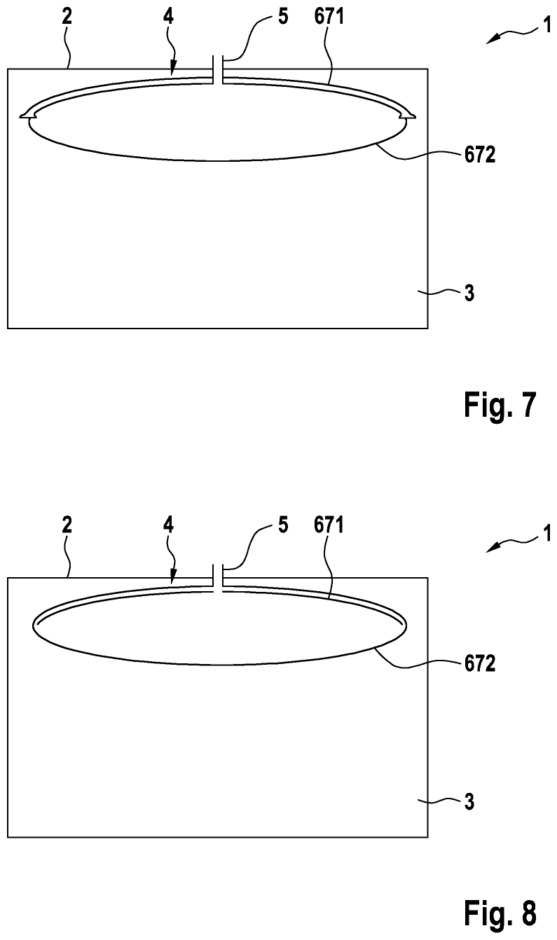

FIG. 7 shows a schematic view of a tank according to the invention having a two-shell volume element,

FIG. 8 shows a schematic view of a tank according to the invention having a two-shell volume element with a shell frame,

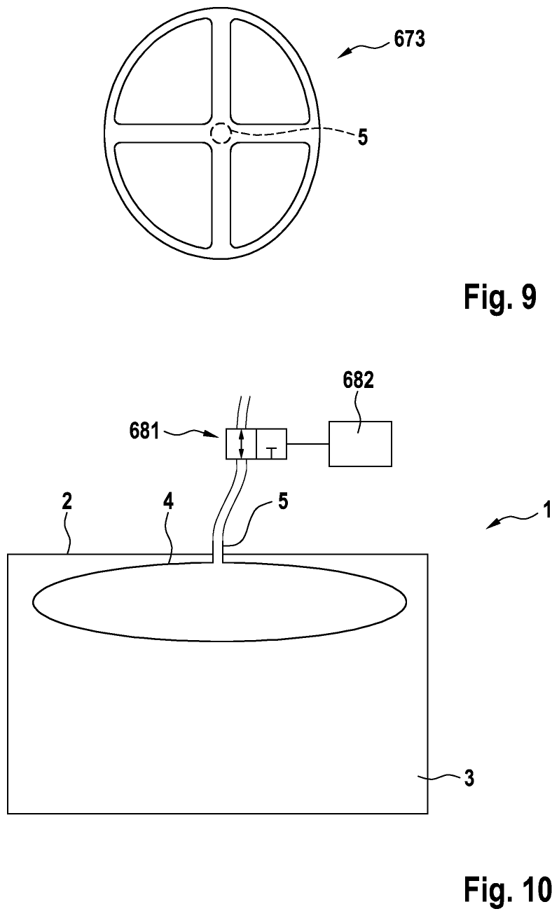

FIG. 9 shows a schematic view of the shell frame from FIG. 8,

FIG. 10 shows a schematic view of a tank according to the invention having a volume element and shutoff valve,

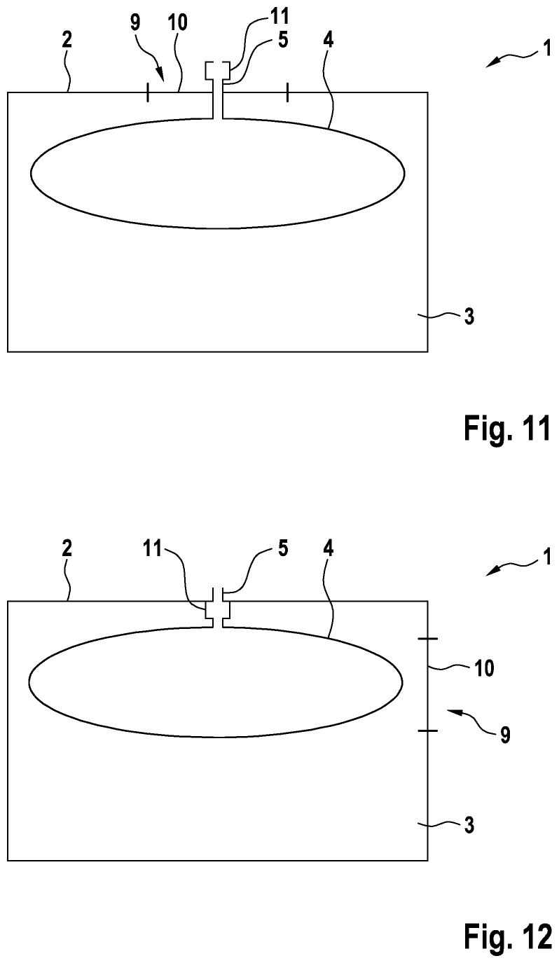

FIG. 11 shows a schematic view of a tank according to the invention having a replaceable volume element according to a first variant, and

FIG. 12 shows a schematic view of a tank according to the invention having a replaceable volume element according to a second variant.

The figures show strictly schematic views of a tank 1 that is designed as a fuel tank for a vehicle. The tank 1 includes an outer wall 2 that forms an internal space 3 for receiving the fuel. A volume element 4 is situated in the internal space 3. The volume element 4 is connected to the surroundings via a line 5.

The volume of the volume element 4 changes as a function of the filling level and/or the internal pressure in the internal space 3, wherein gas, in particular air, is pressed or drawn out of the volume element 4 to the outside via the line 5.

FIGS. 1 through 10 describe different embodiments of a stabilizing assembly 6. As described in the introductory section, these stabilizing assemblies 6 may be combined with one another. For a clear, straightforward illustration of the various variants of the stabilizing assembly 6, these variants are described individually with reference to the figures, despite the fact that they can be combined with one another.

It is preferably provided that the stabilizing assembly 6 includes at least one internal body 61-64 in the interior of the volume element 4. Examples of such internal bodies 61-64 are described in greater detail with reference to FIGS. 1 through 4.

FIG. 1 shows a schematic view of the tank 1 having a volume element 4, and an internal body 61 designed as a gas-filled bladder. The gas-filled bladder is elastically deformable. The bladder is situated in the interior of the volume element 4 and is closed, so that the same mass of gas is always present in the bladder. The closed bladder is in particular filled with air.

FIG. 2 shows a schematic view of the tank 1 together with a volume element 4 and a flat internal body 62 made of an elastically deformable material. This internal body 62 is not only elastically deformable but also elastically compressible. For this purpose, the internal body 62 is made of an open-pore sponge.

FIG. 3 shows a schematic view of the tank 1 having a volume element 4 and a resilient structure as the internal body 63. The resilient structure is elastically deformable. The resilient structure is formed by a deformable hollow body. The hollow body is cylindrical in this case.

FIG. 4 shows a schematic view of the tank 1 having a volume element 4 and a flat frame as the internal body 64. The frame has a round or oval shape. The frame is in particular rigid, and thus is not, or essentially not, deformable. The frame in the inflated state of the volume element 4 does not determine the shape of the volume element 4, and merely ensures tightening of the volume element 4 when the volume element 4 is evacuated.

FIG. 4A shows a schematic view of the tank 1 having a volume element 4 and a flat frame as the internal body 64. The frame has a pentagonal shape. The volume element 4 in the inflated state rests against the frame and presses the sides inwardly during inflation.

FIG. 4B shows a schematic view of the volume element 4 and a stabilizing frame 69 as the stabilizing assembly 6. The stabilizing frame 69 is fixedly connected to the volume element 4. The stabilizing frame 69 extends around the entire circumference of the volume element 4. The volume element 4 is formed here by two shell-shaped, flexible parts by way of example, the stabilizing frame 69 being situated in the seam region between the two parts.

The stabilizing frame 69 has a pentagonal shape. The sides are inwardly curved. The volume of the volume element 4 increases in both directions perpendicular to the stabilizing frame 69 during inflation. The stabilizing frame 69 remains essentially dimensionally stable, wherein the inwardly curved sides may be slightly inwardly deformed.

FIG. 5 shows a schematic view of the tank 1 having a volume element 4. The stabilizing assembly 6 is formed here by tension elements 65. The tension elements 65 exert a tensile force on the volume element 4, at least when the volume element 4 is evacuated. The volume element 4 is thus drawn flat in the evacuated state.

FIG. 6 shows a schematic view of the tank 1 having a volume element 4. The stabilizing assembly 6 is formed by the volume element 4 itself and an outer bladder 66 that encloses the volume element 4. The volume element 4 is designed as an elastic bladder that can contract and expand. The inner bladder that represents the volume element 4 is situated only within the outer bladder 66, and is not flatly joined to the outer bladder 66.

FIG. 7 shows a schematic view of the tank 1 having a volume element 4. The stabilizing assembly 6 is formed by a two-shell design of the volume element 4. The volume element 4 thus includes a rigid first shell 671 and a flexible second shell 672. The opening to the line 5 is situated on the rigid first shell 671. The two shells 671, 672 together form the gas-receiving volume of the volume element 4. The rigid shell 671 remains unchanged during the evacuation of the volume element 4, wherein the volume of the flexible shell 672 is reduced.

FIG. 8 shows a schematic view of the tank 1 having a volume element 4. The stabilizing assembly 6 is formed by a two-shell design of the volume element 4. The entire volume element 4 is formed by a stretchable bladder, in particular made of an elastomer. The rigid shell 671 results from a rigid shell frame 673 that is fixedly connected to a portion of the bladder. FIG. 9 shows a top view of this shell frame 673. The shell frame 673 has a shell shape. It is provided that such a shell frame 673 is provided on the inner side and/or the outer side of the bladder. The portion of the bladder that does not rest against the shell frame 673 functions here as a flexible shell 672.

FIG. 10 shows a schematic view of the tank 1 having a volume element 4. The stabilizing assembly 6 is formed by a shutoff valve 681 in the line 5. The stabilizing assembly 6 also includes a control device 682. This control device 682 is designed to close the shutoff valve 681 when the residual volume is reached.

FIGS. 11 and 12 show schematic views of the tank 1 having a volume element 4. This tank 4 may include no, or one or more of the, described stabilizing assemblies 6.

The volume element 4 is exchangeably situated in the internal space 3 of the tank 4. For this purpose, the outer wall 2 includes a service opening 9 that is designed for removing and reinserting the volume element 4 from/into the internal space 3.

According to FIG. 11, the service opening 9 is closed by a cover 10 that is part of the outer wall 2. The line 5 leads through this cover 10. The volume element 4 is preferably fastened only to this cover 10, for example via the line 5. By removing the cover 10, the volume element 4 at the same time is withdrawn from the internal space 3. The new volume element 4 may be attached to the cover 10 and inserted together with the cover.

The tank 1 according to FIG. 12 includes a connecting element 11 that is actuatable without tools, in the internal space 3 on the line 5. The volume element 4 may be attached to and removed from the line 5, without using a tool, via this connecting element 11. In the design according to FIG. 11, such a connecting element 11 may also be used in the internal space 3 or outside the internal space 3.

### LIST OF REFERENCE NUMERALS

1 tank
2 outer wall
3 internal space
4 volume element
5 line
6 stabilizing assembly
9 service opening
10 cover
11 connecting element
61 internal body designed as a gas-filled bladder
62 internal body made of an elastically deformable material
63 internal body designed as a resilient structure
64 internal body designed as a frame
65 tension element
66 outer bladder
69 stabilizing frame
671 rigid first shell
672 flexible second shell
673 shell frame
681 shutoff valve
682 control device

What is claimed is:

1-19. (canceled)

20. A tank, for receiving a liquid in a motor vehicle, comprising:
an outer wall that forms an internal space for receiving the liquid;
at least one volume element situated in the internal space for receiving gas, in particular air;
a gas-guiding line between the volume element and the surroundings of the tank for changing the volume of the volume element; and
at least one stabilizing assembly for minimizing stresses at kinks of the volume element when evacuating the volume element.

21. The tank according to claim 20, wherein the stabilizing assembly includes at least one internal body in the interior of the volume element, wherein the volume element in the evacuated state rests against this internal body.

22. The tank according to claim 21, wherein the internal body is elastically deformable.

23. The tank according to claim 21, wherein the internal body is a closed, gas-filled bladder.

24. The tank according to claim 21, wherein the internal body is made of an elastically deformable material, preferably an open-pore foam or an elastomer.

25. The tank according to claim 21, wherein the internal body is designed as a resilient structure, preferably as an elastically deformable hollow body.

26. The tank according to claim 21, wherein the internal body is designed as a frame that preferably has a round, oval, or polygonal shape.

27. The tank according to claim 20, wherein the stabilizing assembly includes at least one stabilizing frame that is fixedly connected to the volume element.

28. The tank according to claim 20, wherein the stabilizing assembly is formed by the volume element and an outer bladder that encloses the volume element as a barrier against hydrocarbons.

29. The tank according to claim 20, wherein the stabilizing assembly has a coating of the volume element on its inner side and/or outer side, wherein the coating includes an elastic material, preferably fluororubber (FKM), acrylonitrile butadiene rubber (NBR), or fluorosilicone rubber (FVMQ).

30. The tank according to claim 20, wherein the stabilizing assembly includes at least one elastic tension element that extends through the internal space and is situated between the volume element and the outer wall.

31. The tank according to claim 20, wherein the stabilizing assembly is formed by a two-shell design of the volume element, having a rigid first shell and a flexible second shell.

32. The tank according to claim 31, wherein in the inflated state of the volume element the rigid first shell forms a larger volume than does the flexible second shell.

33. The tank according to claim 31, wherein:
the flexible second shell is fastened, preferably integrally bonded, to the rigid first shell; or
the entire volume element is formed by a bladder, wherein for forming the fixed shell, a portion of the bladder always rests against a shell frame and is fastened to the shell frame.

34. The tank according to claim 20, wherein the stabilizing assembly includes a shutoff valve in the line for maintaining a residual volume of the volume element.

35. The tank according to claim 34, wherein the stabilizing assembly includes a control device that is designed to close the shutoff valve when the residual volume is reached.

36. A tank for receiving a liquid in a motor vehicle, comprising:
an outer wall that forms an internal space for receiving the liquid;
a volume element situated in the internal space for receiving gas, in particular air;
a gas-guiding line between the volume element and the surroundings of the tank for changing the volume of the volume element;
wherein the volume element is exchangeably situated in the internal space, and the outer wall includes a service opening that is designed for removing and reinserting the volume element from/into the internal space.

37. The tank according to claim 36, wherein the volume element is attached to the line via a connecting element that is actuatable without tools.

38. The tank according to claim 36, wherein the line leads through a cover that closes the service opening, and the volume element is fastened to the cover the line.
